(19) United States
(12) Patent Application Publication
(10) Pub. No.: US 2026/0055032 A1
(43) Pub. Date: Feb. 26, 2026

(54) METHOD FOR PREPARING LOW-TEMPERATURE SINTERED HIGH-DIELECTRIC CONSTANT GYROMAGNETIC FERRITE MATERIAL

(71) Applicant: Shenzhen Huayang Technology Development Co., Ltd, Shenzhen (CN)

(72) Inventors: Yuanyong Xu, Shenzhen (CN); Jing Ni, Shenzhen (CN); Wei Zhang, Shenzhen (CN); Hua Peng, Shenzhen (CN)

(21) Appl. No.: 19/377,033

(22) Filed: Nov. 2, 2025

Related U.S. Application Data
(63) Continuation of application No. PCT/CN2023/136169, filed on Dec. 4, 2023.

(30) Foreign Application Priority Data
May 11, 2023 (CN) 202310532107.X

(51) Int. Cl. C04B 35/26; C04B 35/626; C04B 35/64

(52) U.S. Cl. CPC C04B 35/2633; C04B 35/6261; C04B 35/62655; C04B 35/62695; C04B 35/64; C04B 2235/3208; C04B 2235/3225; C04B 2235/3232; C04B 2235/3239; C04B 2235/3244; C04B 2235/3256; C04B 2235/3274; C04B 2235/36; C04B 2235/606; C04B 2235/6562

(57) ABSTRACT

The present disclosure relates to the technical field of electronic materials, and in particular to a low-temperature sintered high-dielectric constant gyromagnetic ferrite material and a preparation method therefor. The low-temperature sintered high-dielectric constant gyromagnetic ferrite material has the molecular formula of Bi_{1.45}Ti_{0.1}Y_{1.55-2x-y}Ca_{2x+y}VₓZr_{yF-0.1}Fe_{5-y-x}O₁₂, wherein x is 0.6-0.65, y is 0.25-0.35, and 1.55-2x-y is ≥0. The preparation method provided by the present disclosure not only can realize low-temperature sintering at 900° C., but also can realize good co-firing compatibility with a silver electrode of a low temperature co-fired ceramics (LTCC) process.

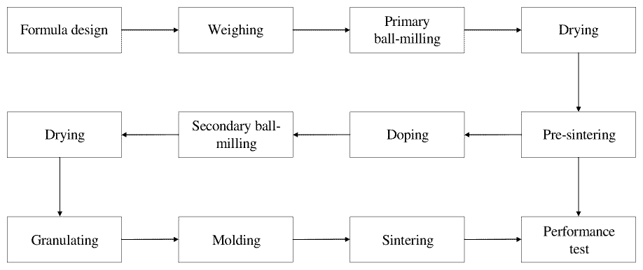

### CROSS-REFERENCE TO RELATED APPLICATIONS

This application is a continuation application of International Application No. PCT/CN2023/136169, filed on Dec. 4, 2023, which claims priority to Chinese Application No. 202310532107.X, filed on May 11, 2023. The disclosures of the above-mentioned applications are hereby incorporated by reference in their entireties.

### TECHNICAL FIELD

The present disclosure relates to the technical field of electronic materials, and in particular to a low-temperature sintered high-dielectric constant gyromagnetic ferrite material and a preparation method therefor.

### BACKGROUND

Microwave gyromagnetic ferrite devices represented by circulators and isolators play a very important role in modern wireless communication systems. In recent years, with the rapid development of wireless communication technology for national defense and civil use, the development trend of miniaturization, broadband and multifunction is increasingly evident in various communication electronic products, such that the microwave gyromagnetic devices widely used in the communication electronic products must also be continuously developed towards miniaturization and integration. Since the wavelength of electromagnetic waves propagating through a medium is inversely proportional to the square root of a dielectric constant, increasing the dielectric constant of gyromagnetic ferrite materials first becomes an important means for realizing the miniaturization of the microwave ferrite devices.

A low temperature co-fired ceramics (LTCC) technology can realize the three-dimensional structure design and packaging of passive electronic components, is more favorable for realizing the miniaturization and integration development of the electronic components, and provides a new way for the innovative structure design of the electronic components. Although the current LTCC technology has been widely used in many passive electronic components, it has hardly been involved in the gyromagnetic devices. This is mainly because the sintering temperature of the conventional gyromagnetic YIG ferrite material is too high, while the LTCC technology uses silver as a co-fired electrode material.

If compatibility with the LTCC process is required, the gyromagnetic material must be sintered to dense at the temperature reduced to 900° C. or less. The general dielectric constant of a commercially available low-linewidth gyromagnetic YIG ferrite material at present is only 13-15, and the sintering temperature is as high as 1300-1450° C. Therefore, it is very difficult to meet the target requirements of high dielectric constant, low-temperature sintering and low ferromagnetic resonance line width at the same time, and comprehensive innovative adjustment in material formula and process is required.

### SUMMARY

The present disclosure provides a method for preparing a low-temperature sintered high-dielectric constant gyromagnetic ferrite material, including the following steps:
S1: taking Bi₂O₃, Y₂O₃, TiO₂, CaCO₃, V₂O₅, ZrO₂ and Fe₂O₃ as initial raw materials, performing batching according to molecular formula of a gyromagnetic ferrite material, and then sequentially performing mixing, ball-milling, drying and pre-sintering to obtain a pre-sintered material, wherein the molecular formula is Bi_{1.45}Ti_{0.1}Y_{1.55-2x-y}Ca_{2x+y}VₓZr_{y-0.1}Fe_{5-y-x}O₁₂, x is 0.6-0.65, y is 0.25-0.35, and 1.55-2x-y is ≥0;
S2: after the pre-sintered material is coarsely crushed, adding a BBSZ (Bi₂O₃—H₃BO₃—SiO₂—ZnO) glass and MoO₃, performing secondary ball-milling, and drying to obtain a re-dried material; and
S3: sequentially granulating, press-molding and sintering the re-dried material to obtain the gyromagnetic ferrite material.

### BRIEF DESCRIPTION OF THE DRAWINGS

The sole FIGURE is a process flow diagram of a method for preparing a low-temperature sintered high-dielectric constant gyromagnetic ferrite material according to the embodiment of the present disclosure.

### DETAILED DESCRIPTION OF THE EMBODIMENTS

The most key concept of the present disclosure is: the high-dielectric constant gyromagnetic ferrite material has the molecular formula of Bi_{1.45}Ti_{0.1}Y_{1.55-2x-y}Ca_{2x+y}VₓZr_{y-0.1}Fe_{5-y-x}O₁₂, and not only can realize low-temperature sintering at 900° C., but also can realize good co-firing compatibility with a silver electrode of an LTCC process.

The low-temperature sintered high-dielectric constant gyromagnetic ferrite material of the present disclosure has the molecular formula of Bi_{1.45}Ti_{0.1}Y_{1.55-2x-y}Ca_{2x+y}VₓZr_{y-0.1}Fe_{5-y-x}O₁₂, wherein x is 0.6-0.65, y is 0.25-0.35, and 1.55-2x-y is ≥0.

The low-temperature sintered high-dielectric constant gyromagnetic ferrite material of the present disclosure can finally reach the performances of 4πMs of about 780-830 Gs, a dielectric constant of about 26.5-27.5 and a ferromagnetic resonance line width of ≤25 Oe, and not only can realize low-temperature sintering at 900° C., but also can realize good co-firing compatibility with the silver electrode of the LTCC process.

The formula of the present disclosure firstly uses the co-substitution of Ca and V ions to obtain the required 47πMs, then improves the dielectric constant by the substitution of proper Bi ions, finally further improves the dielectric constant by the co-substitution of the Ca and Ti ions, and has the following advantages:
(1) the substitution amount of the Bi ion in the gyromagnetic ferrite is controlled to be 1.45, such that the comprehensive requirements of high dielectric constant and low ferromagnetic resonance line width of the material can be taken into consideration to the greatest extent. Meanwhile, the sintering temperature of the material system is not too high, which is beneficial to further reducing the sintering temperature to 900° C. later.
(2) 0.1 mol of Ti ion is strictly controlled for substitution, which is not only beneficial to improving the dielectric constant of the material system, but also can control the ferromagnetic resonance line width of the material not to be too high. The combined substitution of the Ti and Ca ions can satisfy the valence state balance.
(3) a method of Ca, V and Zr ion co-substitution is used. On one hand, the method can regulate and control the 4πMs of the material system to be about 780-830 Gs by a proper substitution amount, thereby meeting the design requirement of a low-field gyromagnetic device; on the other hand, the method further reduces the sintering temperature of the material system by the substitution with a large dose of V ions, which is more beneficial to realizing the low-temperature sintering of the material system. A proper substitution of Bi and V ions not only improves the dielectric constant and adjusts the 4πMs value, but also reduces the sintering temperature of the material system as much as possible. In addition, a proper amount of the Ca and Zr ion substitution is further beneficial to reducing the ferromagnetic resonance line width of the material system.

In one or more examples, the sole FIGURE is referred. A method for preparing the low-temperature sintered high-dielectric constant gyromagnetic ferrite material includes the following steps:
S1: taking Bi₂O₃, Y₂O₃, TiO₂, CaCO₃, V₂O₅, ZrO₂ and Fe₂O₃ as initial raw materials, performing batching according to molecular formula of a gyromagnetic ferrite material, and then sequentially performing mixing, ball-milling, drying and pre-sintering to obtain a pre-sintered material;
S2: after the pre-sintered material is coarsely crushed, adding a BBSZ glass and MoO₃, performing secondary ball-milling, and drying to obtain a re-dried material; and
S3: sequentially granulating, press-molding and sintering the re-dried material to obtain the gyromagnetic ferrite material.

It can be known from the above description that the preparation method of the present disclosure is firstly batching the raw materials according to the components, performing primary ball-milling, drying and then pre-sintering, doping a BBSZ glass and MoO₃ in the pre-sintered material during secondary ball-milling, adding a polyvinyl alcohol (PVA) solution for granulating and molding after the secondary ball-milling and drying, and finally sintering for full densification, so as to obtain the gyromagnetic ferrite material having the characteristics of low-temperature sintering, high dielectric constant and low ferromagnetic resonance line width. It is verified by co-firing of the material with Ag powder, no new phase is produced. The method not only can realize low-temperature sintering at 900° C., but also can realize good co-firing compatibility with the silver electrode of the LTCC process, and can be used for research and development of an LTCC gyromagnetic device.

Proper amounts of the BBSZ glass and MoO₃ are doped during the secondary ball-milling. On one hand, the sintering temperature of the material system can be reduced to 900° C. through further liquid-phase flux sintering, so as to realize low-temperature sintering compatible with the LTCC process and improve the density; on the other hand, the material performance can be improved by optimizing the micromorphology of the ferrite material, which is beneficial to reducing the ferromagnetic resonance line width and improving the dielectric constant.

Further, the pre-sintering includes: sieving the dried material obtained after the drying, compacting and perforating, heating to 750-850° C., pre-sintering under heat preservation for 6-8 h, and cooling to obtain the pre-sintered material.

It can be known from the above description that the solid-phase reaction and crystalline grain growth are completed by diffusion of ions and vacancies during the pre-sintering, thereby improving the material performances.

Further, the addition amount of the BBSZ glass is 0.2-0.3 wt % of the weight of the pre-sintered material.

It can be known from the above description that,
further, the weight ratio of the BBSZ glass to the MoO₃ is (2-3):1.

It can be known from the above description that when the doping amount of the BBSZ glass is small, sufficient densification of the material cannot be achieved by low-temperature sintering at 900° C.; when the doping amount of the BBSZ glass is too much, the magnetic performance is reduced, and a typical manifestation is the increase in ferromagnetic resonance line width. The MoO₃ doping is beneficial to improving the micromorphology of the ferrite, such that the crystalline grains grow more uniformly and the average size of the grains is increased. If the doping amount of the MoO₃ is too small, the effect of improving the micromorphology cannot be achieved. If the doping amount is too much, the crystalline grains do not grow uniformly, thereby in turn deteriorating the magnetic performance of the material.

It can be known from the above description that the doping mode of the combined doping of the BBSZ glass+MoO₃ used in the present disclosure can more effectively reduce the sintering temperature of the material system to 900° C., and meanwhile, almost has no influence on the magnetic performance of the material.

Further, the powder material is subjected to the secondary ball-milling until the average particle size is below 1 μm.

It can be known from the above description that the smaller particle size means the larger specific surface area and the higher activity, which is beneficial to reducing the sintering temperature and the reaction time.

Further, a method for preparing the BBSZ glass is: weighing Bi₂O₃, H₃BO₃, SiO₂ and ZnO raw materials, adding deionized water, ball-milling, mixing uniformly and drying, then heating to 950-1050° C., preserving heat for 1 h, pouring into deionized water for rapid quenching, ball-milling the glass slag obtained after the rapid quenching to a particle size of 2-3 μm, and drying to obtain the BBSZ glass.

Further, during the granulating, a polyvinyl alcohol (PVA) solution accounting for 8-12% of the weight of the re-dried material is added.

Further, the sintering includes: heating to 150-200° C. at 2-3° C./min, preserving heat for 1-2 h, draining water, then heating to 500-600° C. at 2-3° C./min, preserving heat for 2-4 h, removing a binder, finally heating to 900° C. at 2-3° C./min, preserving heat for 4-6 h, and cooling to complete the sintering.

It can be known from the above description that the sintering enables the particles inside the material to interact with each other, removes pores, increases density, and completes the solid-phase reaction.

In one or more examples, the sole FIGURE is referred. A method for preparing the low-temperature sintered high-dielectric constant gyromagnetic ferrite material includes the following steps:
S1: taking Bi₂O₃, Y₂O₃, TiO₂, CaCO₃, V₂O₅, ZrO₂ and Fe₂O₃ with the purities of 99.5% or greater as initial raw materials, performing precise batching according to the molecular formula of the gyromagnetic ferrite material of Bi_{1.45}Ti_{0.1}Y_{1.55-2x-y}Ca_{2x+y}VₓZr_{y-0.1}Fe_{5-y-x}O₁₂, wherein x is 0.6-0.65, y is 0.25-0.35, and 1.55-2x-y is ≥0, then mixing and ball-milling for 6 h in a planetary ball mill, and drying;
S2: sieving the dried material obtained after the drying through a 60-mesh sieve, compacting and perforating, heating to 800° C. at a heating rate of 3° C./min, pre-sintering under heat preservation for 6 h, and cooling with a furnace to room temperature to obtain the pre-sintered material;
S3: after the pre-sintered material is coarsely crushed, adding 0.25 wt % of a BBSZ glass and 0.1 wt % of MoO₃ of the pre-sintered material for trace doping; and then performing secondary ball-milling for 6 h in the planetary ball mill until the average particle size of the powder material is below 1 μm and drying to obtain a re-dried material;
wherein a method for preparing the BBSZ glass is: weighing Bi₂O₃, H₃BO₃, SiO₂ and ZnO raw materials according to the proportion of 27% Bi₂03-35% H₃BO₃-6% SiO₂-32% ZnO in mole fraction, adding deionized water, ball-milling, mixing uniformly and drying, then heating to 1000° C., preserving heat for 1 h, pouring into deionized water for rapid quenching, ball-milling the glass slag obtained after the rapid quenching to the particle size of 2.5 μm, and drying to obtain the BBSZ glass;
S4: adding a PVA solution accounting for 10% of the weight of the re-dried material in the re-dried material, and press-molding to obtain a green blank; and
S5: heating the green blank sample to 200° C. at 2° C./min, preserving heat for 2 h, draining water, then heating to 600° C. at 2° C./min, preserving heat for 3 h, removing a binder, finally heating to 900° C. at 2.5° C./min, preserving heat for 5 h, cooling with the furnace to room temperature to complete the sintering and obtain the gyromagnetic ferrite material.

Table 1 shows the test results obtained when x and y are different values in the molecular formula.

TABLE 1

| Molecular formula | | Dielectric | 4πMs | Ferromagnetic resonance line width |
|---|---|---|---|---|
| x | y | constant | (Gs) | (Oe) |
| 0.6 | 0.25 | 27.4 | 825 | 24 |
| 0.6 | 0.30 | 27.5 | 818 | 22 |
| 0.6 | 0.35 | 27.8 | 813 | 20 |
| 0.65 | 0.25 | 26.7 | 782 | 22 |

It can be seen from Table 1 that the low-temperature sintered high-dielectric constant gyromagnetic ferrite material of the present disclosure can finally reach the performance of 4πMs of about 780-830 Gs, the dielectric constant of about 26.5-27.5 and the ferromagnetic resonance line width of ≤25 Oe, and not only can realize low-temperature sintering at 900° C., but also can realize good co-firing compatibility with the silver electrode of the LTCC process.

In one or more examples, a method for preparing the low-temperature sintered high-dielectric constant gyromagnetic ferrite material includes the following steps:
S1: taking Bi₂O₃, Y₂O₃, TiO₂, CaCO₃, V₂O₅, ZrO₂ and Fe₂O₃ with the purities of 99.5% or greater as initial raw materials, performing precise batching according to the molecular formula of the gyromagnetic ferrite material of Bi_{1.45}Ti_{0.1}Y_{1.55-2x-y}Ca_{2x+y}VₓZr_{y-0.1}Fe_{5-y-x}O₁₂, wherein x=0.6 and y=0.25, then mixing and ball-milling for 6 h in a planetary ball mill, and drying;
S2: sieving the dried material obtained after the drying through a 60-mesh sieve, compacting and perforating, heating to 750° C. at a heating rate of 3° C./min, pre-sintering under heat preservation for 8 h, and cooling with a furnace to room temperature to obtain the pre-sintered material;
S3: after the pre-sintered material is coarsely crushed, adding 0.2 wt % of a BBSZ glass and 0.1 wt % of MoO₃ of the pre-sintered material for trace doping; and then performing secondary ball-milling for 6 h in the planetary ball mill until the average particle size of the powder material is below 1 μm and drying to obtain a re-dried material,
wherein a method for preparing the BBSZ glass is: weighing Bi₂O₃, H₃BO₃, SiO₂ and ZnO raw materials according to the proportion of 27% Bi₂03-35% H₃BO₃-6% SiO₂-32% ZnO in mole fraction, adding deionized water, ball-milling, mixing uniformly and drying, then heating to 950° C., preserving heat for 1 h, pouring into deionized water for rapid quenching, ball-milling the glass slag obtained after the rapid quenching to the particle size of 2 μm, and drying to obtain the BBSZ glass;
S4: adding a PVA solution accounting for 8% of the weight of the re-dried material in the re-dried material, and press-molding to obtain a green blank; and
S5: heating the green blank sample to 150° C. at 2.5° C./min, preserving heat for 1.8 h, draining water, then heating to 500° C. at 2.5° C./min, preserving heat for 4 h, removing a binder, finally heating to 900° C. at 2° C./min, preserving heat for 4 h, cooling with the furnace to room temperature to complete the sintering and obtain the gyromagnetic ferrite material.

In one or more examples, a method for preparing the low-temperature sintered high-dielectric constant gyromagnetic ferrite material includes the following steps:
S1: taking Bi₂O₃, Y₂O₃, TiO₂, CaCO₃, V₂O₅, ZrO₂ and Fe₂O₃ with the purities of 99.5% or greater as initial raw materials, performing precise batching according to the molecular formula of the gyromagnetic ferrite material of Bi_{1.45}Ti_{0.1}Y_{1.55-2x-y}Ca_{2x+y}VₓZr_{y-0.1}Fe_{5-y-x}O₁₂, wherein x=0.6 and y=0.25, then mixing and ball-milling for 6 h in a planetary ball mill, and drying;
S2: sieving the dried material obtained after the drying through a 60-mesh sieve, compacting and perforating, heating to 850° C. at a heating rate of 3° C./min, pre-sintering under heat preservation for 7 h, and cooling with a furnace to room temperature to obtain the pre-sintered material;
S3: after the pre-sintered material is coarsely crushed, adding 0.3 wt % of a BBSZ glass and 0.1 wt % of MoO₃ of the pre-sintered material for trace doping; and then performing secondary ball-milling for 6 h in the planetary ball mill until the average particle size of the powder material is below 1 μm and drying to obtain a re-dried material,
wherein a method for preparing the BBSZ glass is: weighing Bi₂O₃, H₃BO₃, SiO₂ and ZnO raw materials according to the proportion of 27% Bi₂03-35% H₃BO₃-6% SiO₂-32% ZnO in mole fraction, adding deionized water, ball-milling, mixing uniformly and drying, then heating to 1050° C., preserving heat for 1 h, pouring into deionized water for rapid quenching, ball-milling the glass slag obtained after the rapid quenching to the particle size of 3 μm, and drying to obtain the BBSZ glass;
S4: adding a PVA solution accounting for 12% of the weight of the re-dried material in the re-dried material, and press-molding to obtain a green blank; and
S5: heating the green blank sample to 170° C. at 3° C./min, preserving heat for 1 h, draining water, then heating to 550° C. at 3° C./min, preserving heat for 2 h, removing a binder, finally heating to 900° C. at 3° C./min, preserving heat for 6 h, cooling with the furnace to room temperature to complete the sintering and obtain the gyromagnetic ferrite material.

In conclusion, the preparation method of the present disclosure is firstly batching the raw materials according to the components, performing primary ball-milling, drying and then pre-sintering, doping a BBSZ glass and MoO₃ into a pre-sintered material during secondary ball-milling, adding a PVA solution for granulating and molding after the secondary ball-milling and drying, and finally sintering for full densification, so as to obtain the gyromagnetic ferrite material having the characteristics of low-temperature sintering, high dielectric constant and low ferromagnetic resonance line width. The material uses the proper substitution of Bi and V ions to improve the dielectric constant, adjust the 4πMs value, and reduces the sintering temperature of the material system as much as possible. Then proper amounts of the BBSZ glass and MoO₃ are doped during the secondary ball-milling. Therefore, the sintering temperature of the material system can be reduced to 900° C. through further liquid-phase flux sintering, so as to realize low-temperature sintering compatible with the LTCC process and improve the density. It is verified by co-firing of the material with Ag powder, no new phase is produced. The method not only can realize low-temperature sintering at 900° C., but also can realize good co-firing compatibility with the silver electrode of the LTCC process, and can be used for research and development of an LTCC gyromagnetic device.

The above description is only examples of the present disclosure, but does not limit the patent scope of the present disclosure. All equivalent modifications made by the description of the present disclosure and the attached drawings, or those directly or indirectly used in the related technical field are all included in the protection scope of the patent of the present disclosure in a similar way.

What is claimed is:

1. A method for preparing a low-temperature sintered high-dielectric constant gyromagnetic ferrite material, comprising the following steps:
S1: taking Bi₂O₃, Y₂O₃, TiO₂, CaCO₃, V₂O₅, ZrO₂ and Fe₂O₃ as initial raw materials, performing batching according to molecular formula of a gyromagnetic ferrite material, and then sequentially performing mixing, ball-milling, drying and pre-sintering to obtain a pre-sintered material, wherein the molecular formula is Bi_{1.45}Ti_{0.1}Y_{1.55-2x-y}Ca_{2x+y}VₓZr_{y-0.1}Fe_{5-y-x}O₁₂, x is 0.6-0.65, y is 0.25-0.35, and 1.55-2x-y is ≥0;
S2: after the pre-sintered material is coarsely crushed, adding a BBSZ glass and MoO₃, performing secondary ball-milling, and drying to obtain a re-dried material; and
S3: sequentially granulating, press-molding and sintering the re-dried material to obtain a gyromagnetic ferrite material.

2. The method for preparing a low-temperature sintered high-dielectric constant gyromagnetic ferrite material according to claim 1, wherein the pre-sintering comprises: sieving the dried material obtained after the drying, compacting and perforating, heating to 750-850° C., pre-sintering under heat preservation for 6-8 h, and cooling to obtain the pre-sintered material.

3. The method for preparing a low-temperature sintered high-dielectric constant gyromagnetic ferrite material according to claim 1, wherein the addition amount of the BBSZ glass is 0.2-0.3 wt % of the weight of the pre-sintered material.

4. The method for preparing a low-temperature sintered high-dielectric constant gyromagnetic ferrite material according to claim 1, wherein the weight ratio of the BBSZ glass to the MoO₃ is (2-3):1.

5. The method for preparing a low-temperature sintered high-dielectric constant gyromagnetic ferrite material according to claim 1, wherein the powder material is subjected to the secondary ball-milling until the average particle size is below 1 μm.

6. The method for preparing a low-temperature sintered high-dielectric constant gyromagnetic ferrite material according to claim 1, wherein a method for preparing the BBSZ glass is: weighing Bi₂O₃, H₃BO₃, SiO₂ and ZnO raw materials, adding deionized water, ball-milling, mixing uniformly and drying, then heating to 950-1050° C., preserving heat for 1 h, pouring into deionized water for rapid quenching to obtain glass slag, ball-milling the glass slag to a particle size of 2-3 μm, and drying to obtain the BBSZ glass.

7. The method for preparing a low-temperature sintered high-dielectric constant gyromagnetic ferrite material according to claim 1, wherein during the granulating, a polyvinyl alcohol (PVA) solution accounting for 8-12% of the weight of the re-dried material is added.

8. The method for preparing a low-temperature sintered high-dielectric constant gyromagnetic ferrite material according to claim 1, wherein the sintering comprises: heating to 150-200° C. at 2-3° C./min, preserving heat for 1-2 h, draining water, then heating to 500-600° C. at 2-3° C./min, preserving heat for 2-4 h, removing a binder, finally heating to 900° C. at 2-3° C./min, preserving heat for 4-6 h, and cooling to complete the sintering.
